(19) United States
(12) Patent Application Publication
(10) Pub. No.: US 2025/0074799 A1
(43) Pub. Date: Mar. 6, 2025

(54) COMPOSITIONS AND METHODS FOR REMOVING METALS FROM MEDIUMS

(71) Applicant: ECOLAB USA Inc., St. Paul, MN (US)

(72) Inventor: Ning JIN, Shanghai (CN)

(73) Assignee: ECOLAB USA Inc., St. Paul, MN (US)

(21) Appl. No.: 18/817,750

(22) Filed: Aug. 28, 2024

Related U.S. Application Data
(60) Provisional application No. 63/580,908, filed on Sep. 6, 2023.

(51) Int. Cl. C02F 1/68; C02F 1/24; C02F 1/62; C02F 101/20

(52) U.S. Cl. CPC C02F 1/68; C02F 1/24; C02F 1/62; C02F 2101/20

(57) ABSTRACT

The compositions and methods disclosed relate to the removal of a metal from a medium, such as an aqueous medium. The aqueous medium may be, for example, wastewater, such as wastewater from the microelectronics industry. Blended compositions were discovered to be synergistically favorable for lowered toxicity and increased coagulating ability in the chemical precipitation of metal contaminants. Compositions may include, for example, polymeric DTC and TMT. Target metals may include, for example, heavy metals, such as copper, nickel, and mercury.

### TECHNICAL FIELD

The present disclosure generally relates to compositions, components, and methods for treating mediums. More specifically, the disclosure relates to compositions and components for removing a metal, such as copper, from a medium, such as wastewater.

### BACKGROUND

Wastewater containing heavy metals arises from processes and use in various industries, such as electroplating, paints and dyes, petroleum refining, fertilizers, mining and metallurgy, explosives, pesticides, and steel. If discharged to a municipal waste system, heavy metals can be very detrimental to the environment and human health. Copper, currently the third most used metal in the world, is becoming an increasing concern in wastewater contamination as its industrial use continues to expand.

As a result, many plants, as required by strict regulations, implement pollution prevention programs that cover a broad range of pollution control methods. One of these methods, chemical precipitation, is widely used due to its cost effectiveness and simplicity of operation allowing it to be effective over a wide range of temperatures.

In the microelectronics industry, traditional methods of treating wastewater streams that contain copper contaminants involve chemical precipitation processes. For example, dithiocarbamate (DTC) is a commonly used reagent for copper removal processes due to its cost-effectiveness. However, DTC are also fungicides and broad-spectrum biocides which when used in excess in effluent, can cause toxicological and ecological distress.

Accordingly, there is a need for more environmentally-friendly choices to remove contaminants, particularly copper metals in microelectronic industrial process wastewater to reduce toxicological and ecological harm.

### BRIEF SUMMARY

The present disclosure provides methods and compositions for treating a medium. In some embodiments, the disclosure provides a composition for the treatment of a medium. The composition comprises trimercapto-s-triazine (TMT) and a polymer comprising a dithiocarbamate (DTC) functional group and an amine functional group. The weight average molecular weight of the polymer is between about 500 to about 200,000 g/mol and the polymer has between about 5 to about 100 mol % of said DTC functional group relative to total DTC and amine functional groups. The composition comprises a mole ratio of TMT to DTC of about 1:1 to about 1:9.

In some embodiments, the weight ratio of TMT to polymer is about 1:1 to about 1:8, about 1:1 to about 1:7, about 1:1 to about 1:6, about 1:1 to about 1:5, about 1:1 to about 1:4, about 1:1 to about 1:3, or about 1:1 to about 1:2.

In some embodiments, the polymer has about 30 mol % to about 80 mol % of the DTC functional group.

In certain embodiments, the polymer is derived from a reaction of an amine functionalized polymer backbone with CS₂. The amine functionalized polymer may be selected from the group consisting of a polyethyleneimine, a copolymer of ethylenedichloride and ammonia, a polyamidoamine, a polyallylamine, a polymer comprising acrylic acid or a derivative thereof and an alkylamine, a polymer comprising methacrylic acid or a derivative thereof and an alkylamine, and any combination thereof, wherein the alkylamine is selected from the group consisting of an ethylenediamine (EDA), a diethylenetriamine (DETA), a triethylenetetraamine (TETA), a tetraethylenepetamine (TEPA), a pentaethylenehexamine (PEHA), and any combination thereof.

In some embodiments, the TMT further comprises a solvent, which comprises about 40% to about 95% of the total weight.

In some embodiments, the polymer comprising the DTC functional group further comprises a solvent, which comprises about 40% to about 95% of the total weight.

In certain embodiments, the composition comprises about 2-10% by weight of the TMT and about 5-20% by weight of the polymer comprising the DTC functional group.

In some embodiments, the composition further comprises an aqueous solvent.

The present disclosure also provides a method of removing a metal from a medium. The method comprises adding TMT and a polymer comprising a DTC functional group to the medium and separating a precipitate comprising the metal from the medium. The weight average molecular weight of the polymer may be between about 500 to about 200,000 g/mol and the polymer may have between about 5 and about 100 mol % of the DTC functional group. The TMT and the DTC functional group in the polymer are added at a mole ratio of about 1:1 to about 1:9.

In some embodiments, the polymer has about 30 mole % to about 80 mole % of the DTC functional group.

In some embodiments, the TMT and the polymer are premixed to form a composition and the composition is added to the medium.

In certain embodiments, the TMT is added to the medium before, after, and/or with the polymer.

In some embodiments, the separating is carried out by a process selected from the group consisting of sedimentation/decanting, filtration, flotation, and any combination thereof.

In some embodiments, the TMT further comprises a solvent, the solvent comprising from about 40-95% of the total weight.

In certain embodiments, the polymer further comprises a solvent, the solvent comprising from about 40-95% of the total weight.

In some embodiments, the composition comprises about 2-10% by weight of the TMT and about 5-20% by weight of the polymer comprising the DTC functional group.

In some embodiments, a measured supernatant turbidity of the medium after addition of the TMT and polymer is less than about 3 nephelometric turbidity units (NTU).

In certain embodiments, the composition is added to the medium at a concentration of about 1 ppm to about 1,000 ppm per ppm of metal present in the medium.

In some embodiments, the metal is selected from the group consisting of copper, nickel, zinc, lead, mercury, cadmium, silver, iron, manganese, palladium, platinum, strontium, arsenic, cobalt, gold, and any combination thereof.

In some embodiments, the medium is an aqueous medium.

In certain embodiments, the method further comprises adding a member selected from the group consisting of a pH adjustment reagent, a coagulant, a flocculant, and any combination thereof, to the medium.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 shows a typical treatment scheme for industrial wastewater heavy metal removal;

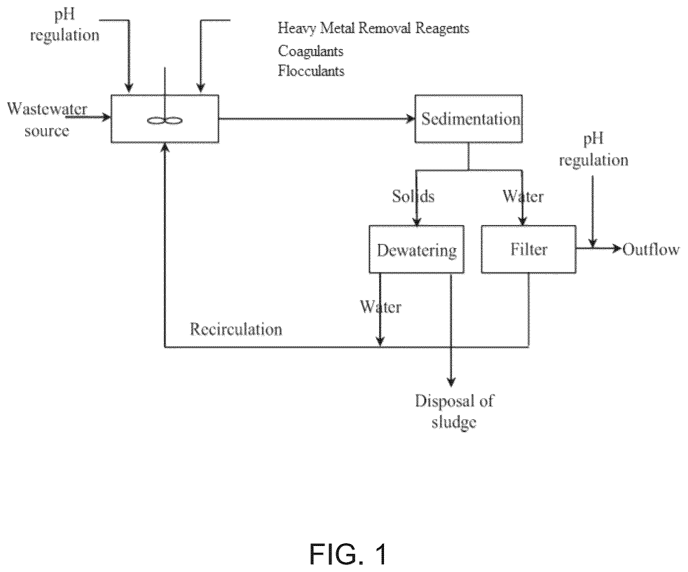

FIG. 2 shows the copper removal performance of blended TMT-15 and polymeric DTC;

FIG. 3 shows the coagulating ability of blended TMT-15 and polymeric DTC;

FIG. 4 shows the copper removal performance of blended TMT-15 and polymeric DTC as well as TMT-15 by itself and polymeric DTC by itself; and

FIG. 5 shows the coagulating ability for a 1:1 w/w blended reagent of TMT-15 and a polymeric DTC solution as well as TMT-15 by itself and polymeric DTC by itself.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroalkyl group” refers to a saturated or unsaturated, substituted or unsubstituted, straight-chained, branched, or cyclic aliphatic group that contains at least 1 heteroatom (e.g., O, S, N, and/or P) in the core of the molecule (i.e., the carbon backbone).

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(-N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The term “polyamine” as used herein means a compound containing two or more imino or amino groups each of which is formed by one or two active hydrogen atoms bonded to a nitrogen atom. Examples of polyamines include, but are not limited to, polyalkylenepolyamines, such as ethylenediamine, propylenediamine, butylenediamine, hexamethylenediamine, diethylenetriamine, dipropylenetriamine, dibutylenetriamine, triethylenetetramine, tripropylenetetramine, tributylenetetramine, tetraethylenepentamine, tetrapropylenepentamine, tetrabutylenepentamine and pentaethylenehexamine; phenylenediamine; xylenediamine; metha-xylenediamine; iminobispropylamine; monomethylaminopropylamine; methyliminobispropylamine; 1,3-bis(aminomethyl)cyclohexane; 1,3-diaminopropane; 1,4-diaminobutane; 3,5-diaminochlorobenzene; melamine; 1-aminoethylpiperazine; piperazine; diaminophenyl ether; 3,3′-dichlorobenzidine; tolidine base; m-toluylenediamine; and polyethylenepolyimine (weight average molecular weight of about 300 or higher. Additional examples include N-alkylpolyamines, N-hydroxyalkylpolyamines and N-acylpolyamines obtained respectively by reacting alkyl halides, epoxyalkanes and fatty acid derivatives with the above-described polyamines. As N-alkylpolyamines, it is possible to use N-alkylethylenediamines, N-alkylpropylenediamines, N-alkylhexamethylenediamines, N-alkylphenylenediamines, N-alkylxylenediamines, N-alkyldiethylenetriamines, N-alkyltriethylenetetramines, N-alkyltetraethylenepentamines, N-alkylpentaethylenehexamine, etc. The above N-substituted alkyl groups may preferably have 2 to 18 carbon atoms. Illustrative, non-limiting examples of N-hydroxyalkylpolyamines include N-hydroxyethylpolyamine, N-hydroxypropylpolyamine, N-hydroxybutylpolyamine, N-β-hydroxydodecylpolyamine, N-β-hydroxytetradecylpolyamine, N-β-hydroxyhexadecylpolyamine, N-β-hydroxyoctadecylpolyamine, N-β-hydroxyoctacosylpolyamine, etc. Examples of N-acylpolyamines include N-acetylpolyamine, N-propionylpolyamine, N-butyrylpolyamine, N-caproylpolyamine, N-lauroylpolyamine, N-oleoylpolyamine, N-myristyloylpolyamine, N-stearoylpolyamine, and N-behenoylpolyamine. These polyamines may be used either alone or in any combination. On the other hand, epichlorohydrin, epibromohydrin, epiiodohydrin and the like are illustrative, non-limiting examples of epihalohydrins which are subjected to addition with these polyamines.

### Compositions

The compositions and methods disclosed herein relate to the removal of a metal from a medium, such as an aqueous medium. For example, the compositions are useful for removing copper from wastewater, such as wastewater from the microelectronics industry. As shown in the examples of the present application, blended compositions were discovered to be synergistically favorable for lowered toxicity and increased coagulating ability in the chemical precipitation of copper contaminants.

In certain embodiments, a synergistic composition disclosed herein includes a polymer comprising a DTC functional group (which may also be referred to as “polymeric DTC” throughout the present disclosure) and TMT. The polymeric DTC may optionally comprise an amine functional group. As further described in the examples of the present application, the polymeric DTC and the TMT displayed synergy when mixed together for treatment of industrial wastewater, giving unexpectedly superior aquatic toxicity and coagulating ability.

Polymers comprising DTC functional groups have several advantages over non-polymeric DTC or other small molecule dithiocarbamates. In polymeric form, DTC is less toxic, has self-coagulating abilities, and forms larger, more easily settled flocs. As a result, when using polymeric DTC, less coagulants and flocculants are needed, less sludge is generated, and the effluent water is a higher quality with a lowered turbidity level. Polymeric DTC is also more effective at lowering heavy metal concentrations than DTC or other small molecule dithiocarbamates. The resulting sludge also releases less heavy metals under leaching conditions.

Polymeric DTC can be derived from, for example, a polymer of ethylene dichloride and ammonia (as described in U.S. Pat. No. 5,164,095), a polyethylenimine (PEI) polymer (as described in U.S. Pat. No. 5,387,365), epichlorohydrin and amine condensation polymer (as described in U.S. Pat. Nos. 4,670,160 and 5,500,133), a polyallylamine polymer (as described in EP 0581164), a polydiallylamine polymer (as described in U.S. Pat. No. 6,403,726), and a condensation polymer of acrylic-X and alkylamine (as described in US 2011/0245453), all of which are incorporated herein by reference.

In certain embodiments, the polymeric DTC includes polyamine derivatives and polyethyleneimine derivatives that contain at least one DTC group or a salt thereof, for example, an alkali metal salt, such as the sodium salt or potassium salt, an alkaline salt, such as the calcium salt, the ammonium salt, or the like, as an N-substituting group substituted for an active hydrogen atom bonded to a nitrogen atom of a polyamine molecule containing primary and/or secondary amino groups or a polyethyleneimine molecule containing primary and/or secondary amino groups. These polyamine derivatives and polyethyleneimine derivatives can be obtained, for example, by reacting carbon disulfide with a polyamine and a polyethyleneimine, respectively. The active hydrogen atom of the terminal DTC group can be replaced by treating the reaction mixture with an alkali such as sodium hydroxide, potassium hydroxide or ammonium hydroxide after the completion of the above reaction or by conducting the above reaction in the presence of an alkali.

In accordance with the present disclosure, the term “DTC” includes a DTC salt, a non-salt form of DTC, and any combination thereof.

In further embodiments, the polymeric DTC contains one or more alkyl groups, hydroxyalkyl groups and/or acyl groups that may be bonded as N-substituent or N-substituents to one or more nitrogen atoms in polyamines. These N-substituent or substituents may be introduced by reacting the polyamine with an alkyl halide, such as methyl halide, ethyl halide, butyl halide, lauryl halide or stearyl halide, an epoxy alkane, such as ethylene oxide, propylene oxide, butylene oxide, styrene oxide, 1,2-dodecylepoxyalkane or 1,2-octacosylepoxyalkane, a fatty acid, such as acetic acid, propionic acid, butyric acid, caproic acid, caprylic acid, lauric acid, myristic acid, palmitic acid, stearic acid or behenic acid, a fatty acid derivative, such as an ester or acid halide of the above fatty acid.

In certain embodiments, the polymeric DTC can be prepared by reacting carbon disulfide with a polyamine including primary, secondary, or tertiary amine groups or by reacting carbon disulfide with allylamine to obtain a monomer (mono- or bis-(dithioic) allylamine or its salt) formed by replacing the hydrogen atom(s) linked to the nitrogen atom of the allylamine by a DTC group.

In certain embodiments, the polymeric DTC may be prepared by polymerizing diallylamine and then subsequently reacting it with CS₂ to form DTC functionalities on the polymer backbone. The diallylamine may also be copolymerized with suitable monomers. For example, the suitable monomers may have an anionic, cationic or neutral charge and may include acrylate, acrylamide or vinyl containing monomers.

In certain embodiments, the polymeric DTC may be prepared by functionalizing a polymer derived from at least two monomers: acrylic-X and an alkylamine. In some embodiments, acrylic-X may be at least one of the following: methyl acrylate, methyl methacrylate, ethyl acrylate, and ethyl methacrylate, propyl acrylate, and propyl methacrylate. In another embodiment, the acrylic-x is at least one of the following: acrylic acid and salts thereof, methacrylic acid and salts thereof, acrylamide, and methacrylamide. In some embodiments, the alkylamine is at least one of the following: an ethyleneamine, a polyethylenepolyamine, ethylenediamine (EDA), diethylenetriamine (DETA), triethylenetetraamine (TETA) and tetraethylenepetamine (TEPA) and pentaethylenehexamine (PEHA).

In certain embodiments, the polymeric DTC may have a weight average molecular weight of about 500 g/mol to about 200,000 g/mol. For example, the weight average molecular weight may be from about 500 g/mol to about 150,000 g/mol, about 500 g/mol to about 100,000 g/mol, about 500 g/mol to about 50,000 g/mol, about 500 g/mol to about 25,000 g/mol, about 500 g/mol to about 10,000 g/mol, about 500 g/mol to about 1,000 g/mol, about 1,000 g/mol to about 200,000 g/mol, about 5,000 g/mol to about 200,000 g/mol, about 10,000 g/mol to about 200,000 g/mol, about 25,000 g/mol to about 200,000 g/mol, about 50,000 g/mol to about 200,000 g/mol, about 100,000 g/mol to about 200,000 g/mol, or about 150,000 g/mol to about 200,000 g/mol. In some embodiments, the weight average molecular weight may be from about 1,000 g/mol to about 15,000 g/mol, about 1,000 g/mol to about 12,000 g/mol, about 1,000 g/mol to about 10,000 g/mol, about 2,000 g/mol to about 15,000 g/mol, about 2,000 g/mol to about 12,000 g/mol, or about 2,000 g/mol to about 10,000 g/mol.

In certain embodiments, the molar amounts of the DTC functional group relative to the total amines contained in the unmodified polymer can vary. For example, the reaction of 3.0 molar equivalents of carbon disulfide to a 1:1 mole ratio of acrylic acid/TEPA copolymer, which contains 4 molar equivalents of amines per repeat unit after polymerization, will result in a polymer that is modified to contain about 75 mol % DTC groups. In other words, 75% of the total amines in the unmodified polymer have been converted to DTC groups.

In certain embodiments, the polymeric DTC has between about 5 to about 100 mol % of the DTC group. For example, the polymer may comprise from about 5 mol % to about 90 mol %, about 5 mol % to about 80 mol %, about 5 mol % to about 70 mol %, about 5 mol % to about 60 mol %, about 5 mol % to about 50 mol %, about 5 mol % to about 40 mol %, about 5 mol % to about 30 mol %, about 5 mol % to about 20 mol %, about 5 mol % to about 10 mol %, about 10 mol % to about 100 mol %, about 20 mol % to about 100 mol %, about 30 mol % to about 100 mol %, about 40 mol % to about 100 mol %, about 50 mol % to about 100 mol %, about 60 mol % to about 100 mol %, about 70 mol % to about 100 mol %, about 80 mol % to about 100 mol %, or about 90 mol % to about 100 mol % of the DTC functional group. In some embodiments, the polymeric DTC has between about 30 mol % and about 80 mol %, about 30 mol % and about 70 mol %, about 30 mol % and about 60 mol %, or about 30 mol % and about 50 mol % of the DTC group.

The polymer comprising the DTC functional group may include one or more additional monomers. In some embodiments, the polymer may comprise a monomer selected from a cationic monomer, an anionic monomer, a zwitterionic monomer, a non-ionic monomer, and any combination thereof.

The synergistic compositions disclosed herein may also comprise a solvent and/or any component disclosed herein, such as TMT or polymeric DTC, may comprise a solvent.

In some embodiments, the solvent may be an aqueous solvent, such as water. In certain embodiments, NaOH or KOH may be added to the solvent to stabilize the composition and the total weight of the NaOH or KOH could be, for example, less than about 5%, 4%, 3%, 2%, or 1% (w/w).

In certain embodiments, a solvent comprises the TMT. In some embodiments, the solvent may comprise from about 40 wt. % to about 95 wt. % of the TMT, such as from about 40 wt. % to about 85 wt. %, about 40 wt. % to about 75 wt. %, about 40 wt. % to about 65 wt. %, about 40 wt. % to about 55 wt. %, about 50 wt. % to about 95 wt. %, about 60 wt. % to about 95 wt. %, about 70 wt. % to about 95 wt. %, about 80 wt. % to about 95 wt. %, about 85 wt. % to about 95 wt. %, about 70 wt. % to about 90 wt. %, or about 80 wt. % to about 85 wt. % of the TMT.

In certain embodiments, a solvent comprises the polymeric DTC. In some embodiments, the solvent comprises from about 40 wt. % to about 95 wt. % of the polymeric DTC, such as from about 40 wt. % to about 85 wt. %, about 40 wt. % to about 75 wt. %, about 40 wt. % to about 65 wt. %, about 40 wt. % to about 55 wt. %, about 45 wt. % to about 95 wt. %, about 55 wt. % to about 95 wt. %, about 65 wt. % to about 95 wt. %, about 75 wt. % to about 95 wt. %, about 80 wt. % to about 95 wt. %, about 70 wt. % to about 90 wt. %, or about 70 wt. % to about 80 wt. % of the polymeric DTC.

In certain embodiments, the TMT and the polymeric DTC may be added separately to a medium, such as wastewater, and a composition comprising the polymeric DTC and TMT may be formed in the medium. In some embodiments, a composition including TMT and polymeric DTC may be formed outside of the medium and added to the medium. In some embodiments, the composition may comprise between about 1 wt. % and about 20 wt. % of the TMT. For example, the composition may comprise from about 3 wt. % to about 20 wt. %, about 5 wt. % to about 20 wt. %, about 7 wt. % to about 20 wt. %, about 9 wt. % to about 20 wt. %, about 11 wt. % to about 20 wt. %, about 13 wt. % to about 20 wt. %, about 15 wt. % to about 20 wt. %, about 17 wt. % to about 20 wt. %, about 1 wt. % to about 18 wt. %, about 1 wt. % to about 16 wt. %, about 1 wt. % to about 14 wt. %, about 1 wt. % to about 12 wt. %, about 1 wt. % to about 10 wt. %, about 1 wt. % to about 8 wt. %, about 1 wt. % to about 6 wt. %, or about 1 wt. % to about 4 wt. % or the TMT.

In some embodiments, the composition includes between about 1 wt. % and about 30 wt. % of the polymeric DTC. For example, the composition may include between about 1 wt. % and about 25 wt. %, about 1 wt. % and about 20 wt. %, about 1 wt. % and about 15 wt. %, about 1 wt. % and about 10 wt. %, about 1 wt. % and about 5 wt. %, about 5 wt. % and about 30 wt. %, about 10 wt. % and about 30 wt. %, about 15 wt. % and about 30 wt. %, about 20 wt. % and about 30 wt. %, or about 25 wt. % and about 30 wt. % of the polymeric DTC.

The amount of solvent in the composition is not particularly limited and may be selected by one of ordinary skill in the art. In some embodiments, the composition may comprise from about 1 wt. % to about 99 wt. % of the solvent, such as from about 10 wt. % to about 99 wt. %, about 20 wt. % to about 99 wt. %, about 30 wt. % to about 99 wt. %, about 40 wt. % to about 99 wt. %, about 50 wt. % to about 99 wt. %, about 60 wt. % to about 99 wt. %, about 70 wt. % to about 99 wt. %, about 80 wt. % to about 99 wt. %, about 90 wt. % to about 99 wt. %, about 10 wt. % to about 90 wt. %, about 10 wt. % to about 80 wt. %, about 10 wt. % to about 70 wt. %, about 10 wt. % to about 60 wt. %, about 10 wt. % to about 50 wt. %, about 10 wt. % to about 40 wt. %, about 30 wt. % to about 80 wt. %, or about 40 wt. % to about 60 wt. % of the solvent.

The compositions of the present disclosure may include certain weight ratios of various components. For example, a composition disclosed herein may include TMT and polymeric DTC in a ratio ranging from about 1:1 to about 1:9, such as from about 1:1 to about 1:7, about 1:1 to about 1:5, about 1:1 to about 1:3, or about 1:1 to about 1:2. In certain embodiments, the ratio is about 1:1, about 1:2, about 1:3, or about 1:4. If each component is added separately to the aqueous medium to form the composition in the aqueous medium, the amount of each component added may be selected to ensure that the aqueous medium comprises the components in the aforementioned ratios.

### Methods

The present disclosure also provides methods of using the foregoing components and/or compositions in methods of treating mediums, such as methods of removing a metal, e.g., copper, from an aqueous medium, such as wastewater. The methods include adding the TMT and the polymeric DTC separately and/or as components in a composition to the wastewater.

In certain embodiments, the method includes a premixing step, wherein the TMT and the polymeric DTC are premixed to form a composition. The composition is added to the medium, a precipitate containing a metal in the medium, such as copper, is formed, and the precipitate is separated from the medium.

The TMT, polymeric DTC, and/or composition comprising polymeric DTC and TMT may be added to the medium, such as wastewater, in any order. In certain embodiments, the TMT is added before, after, and/or with the polymeric DTC. In some embodiments, the TMT is added to the medium before the polymeric DTC. In some embodiments, the TMT is added to the medium with the polymeric DTC. In some embodiments, the TMT is added to the medium after the polymeric DTC. Each component and/or composition may be added continuously, intermittently, or a combination thereof, to the medium.

The method of carrying out the separation step is not particularly limited and may be selected by one of ordinary skill in the art. In some embodiments, separating a precipitate comprising a metal, such as copper, from the medium, such as wastewater, is carried out using a separation method selected from the group consisting of sedimentation/decanting, filtration, flotation, and any combination thereof. In some embodiments, the separation method may include sedimentation/decanting to separate the metal-containing precipitate. In some embodiments, the separation method may include filtration to separate the metal-containing precipitate. In some embodiments, the separation method may include flotation to separate the metal-containing precipitate. In some embodiments, the separation method may include a combination of sedimentation/decanting, filtration, and flotation to separate the metal-containing, such as copper-containing, precipitate.

Methods disclosed herein are useful for removing various metals from mediums, such as wastewater streams. In some embodiments, the metal is selected from the group consisting of copper, nickel, zinc, lead, mercury, cadmium, silver, iron, manganese, palladium, platinum, strontium, arsenic, cobalt, gold, and any combination thereof. For example, the metal may be copper, nickel, mercury, or any combination thereof.

The compositions and methods disclosed herein can be applied to any medium, such as aqueous systems (e.g., wastewater streams) from power plants, mining operations, waste incineration, microelectronics production, and/or manufacturing operations, for example.

Mediums containing metals may also include a wastewater streams, a liquid hydrocarbonaceous stream, a flue gas stream, and any combination thereof.

In some embodiments, the medium is a liquid hydrocarbonaceous stream found in, for example, petroleum refining processes or petrochemical processes. Examples include streams from these processes that contain petroleum hydrocarbons, such as petroleum hydrocarbon feedstocks including crude oils and fractions thereof, such as naphtha, gasoline, kerosene, diesel, jet fuel, fuel oil, gas oil vacuum residual, etc., or olefinic or napthenic process streams, ethylene glycol, aromatic hydrocarbons, and their derivatives.

In some embodiments, the wastewater stream may be from the microelectronics industry.

If the medium is an aqueous medium, the medium may comprise any pH. In some embodiments, the pH may be from about 1 to about 14, from about 2 to about 13, from about 3 to about 12, from about 4 to about 11, from about 5 to about 10, from about 6 to about 9, from about 7 to about 8, about 6, about 7, about 8, or about 9. If a particular pH is desired, the pH can be obtained through the use of suitable acids (e.g., HCl) or bases (e.g., NaOH) by adding the acid or base to the aqueous medium before, after, and/or with the composition or component.

In certain embodiments, the present disclosure provides a method of removing a metal, such as copper, from a medium, such as wastewater, including adding TMT and a polymer comprising a DTC functional group to the medium and separating a precipitate comprising the metal from the medium where the measured supernatant turbidity of the separated supernatant is less than about 5 nephelometric turbidity units (NTU), such as less than about 4 NTU, less than about 3 NTU, less than about 2 NTU, less than about 1 NTU, from about 0 to about 5 NTU, from about 0 to about 4 NTU, from about 0 to about 3 NTU, from about 0 to about 2 NTU, from about 0 to about 1 NTU, from about 1 NTU to about 2 NTU, from about 1 NTU to about 3 NTU, from about 1 NTU to about 4 NTU, or from about 1 NTU to about 5 NTU.

The precipitate may comprise, for example, a member selected from the metal, polymeric DTC, TMT, a suspended solid from the wastewater influent, a precipitate formed by a coagulant and/or a flocculant (which are dosed subsequent to metal removal to accelerate sedimentation), and any combination thereof.

In some embodiments, the supernatant of the precipitation solution has decreased toxicity. For example, the supernatant of the precipitation solution may have an acute toxicity of less than about 3 acute toxicity units (TUa), such as less than about 2 TUa, less than about 1 TUa, from about 0 to about 3 TUa, from about 0 to about 2 TUa, from about 0 to about 1 TUa, from about 1 TUa to about 2 TUa, or from about 1 TUa to about 3 TUa.

The amount of the composition to be added to the medium depends on certain factors, such as the amount of metal in the medium. In certain embodiments, from about 1 ppm of the composition to about 1,000 ppm of the composition is added to the medium per ppm of metal in the medium. For example, from about 1 ppm to about 750 ppm, about 1 ppm to about 500 ppm, about 1 ppm to about 250 ppm, about 1 ppm to about 200 ppm, about 1 ppm to about 150 ppm, about 1 ppm to about 125 ppm, about 1 ppm to about 100 ppm, about 1 ppm to about 75 ppm, about 1 ppm to about 50 ppm, about 1 ppm to about 25 ppm, about 20 ppm to about 100 ppm, or about 20 ppm to about 125 ppm of the composition comprising the polymeric DTC and the TMT is added to the medium. The composition may comprise any ratio of TMT and polymeric DTC as described herein the present application.

In some embodiments, where the TMT and polymeric DTC are added separately (but in close proximity, such as within about 1-6 inches, about 1-12 inches, about 1-24 inches, about 1-36 inches, about 1-48 inches, about 1-60 inches, about 1-72 inches, about 1-84 inches, or about 1-96 inches from each other) to the wastewater, the TMT may be added in an amount of about 10 ppm to about 30 ppm, such as about 15 ppm to about 25 ppm, about 16 ppm, about 17 ppm, about 18 ppm, about 19 ppm, or about 20 ppm, and the polymeric DTC may be added in an amount of about 10 ppm to about 30 ppm, such as about 15 ppm to about 25 ppm, about 13 ppm, about 14 ppm, about 15 ppm, about 16 ppm, about 17 ppm, or about 18 ppm.

In accordance with certain aspects of the present disclosure, components other than the polymeric DTC and TMT may be added with the methods disclosed herein either as part of a composition with polymeric DTC and/or TMT and/or other components may be added separately from the polymeric DTC and/or TMT. Such additional, optional components may be selected from, for example, a pH adjustment reagent, a coagulant, and/or a flocculant. In some embodiments, a pH adjustment reagent may be added to the wastewater, followed by a metal-removal reagent, a coagulant and a flocculant. The wastewater pH may be adjusted to about 6-8.5, for example. Illustrative, non-limiting examples of a pH adjustment reagent include NaOH and H₂SO₄/HCl. Coagulants may be selected from, for example, aluminum-based coagulants, such as polyaluminum chloride (PAC or PACl) and aluminum chlorohydrate (ACH), iron-based coagulants, such as ferric chloride and polyferric sulfate, and polycationic polymers, such as polyDADMAC (Polydiallyldimethylammonium chloride), and a copolymer of epichlorohydrin and dimethylamine. Coagulant dosages may range from, for example, about 1 ppm to about 100 ppm. A flocculant may be, for example, a cationic or anionic polyacrylamide and a flocculant dosage may range from, for example, about 0.1 ppm to about 5 ppm.

The foregoing may be better understood by reference to the following examples, which are intended for illustrative purposes and are not intended to limit the scope of the disclosure or its application in any way.

### EXAMPLES

### Reagents and Abbreviations

The DTC used was dimethyldithiocarbamate
TMT: 2,4,6-trimercaptotriazine
TMT-15: 15% active solution of trisodium 2,4,6-trimercaptotriazine
PolyDADMAC: polydiallyldimethylammonium chloride

### Example 1. Copper Removal

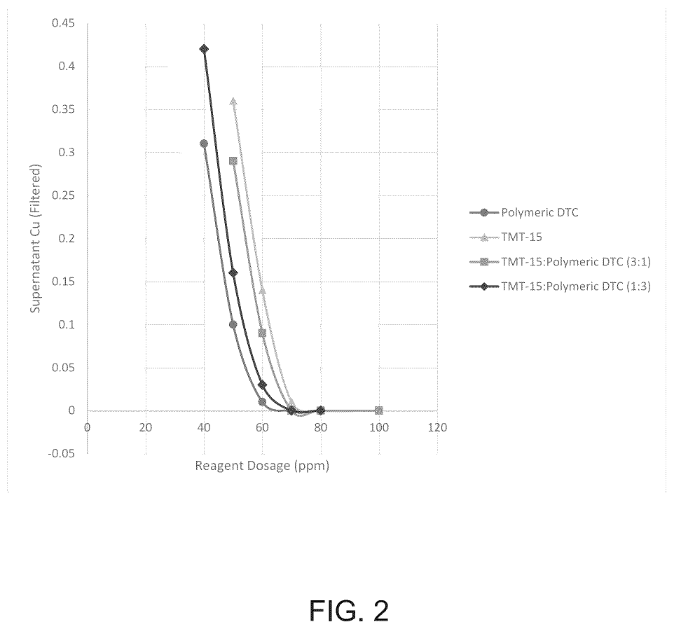

The copper removal performance was measured for the individual components and blended products using a copper chemical mechanical planarization (CMP) wastewater containing about 3.4 ppm copper from a semiconductor fabrication process. Blended products were made by pre-mixing TMT-15 (15% Trisodium trimercapto-s-triazine solution) with a polymeric DTC based on an ethylene dichloride and ammonia copolymer (30% aqueous solution), in about a 1:3 or 3:1 w/w ratio of TMT-15 and polymeric DTC solution. After addition of the copper removal reagents, the wastewater pH was adjusted to about 7.0. The solution was stirred for about 15 minutes followed by the addition of about 100 ppm of aluminum chlorohydrate (23% Al₂O₃) and the pH was adjusted to about 7.0. After stirring for about another 5 minutes, about 1 ppm of an anionic polyacrylamide solution was added. The solution was stirred slowly for about an additional 5 minutes and then allowed to settle for about 20 minutes. The supernatant was taken out and filtered using a 0.45 μm filter. The filtrate was subjected to Cu analysis by ICP. The results are shown in FIG. 2. The copper removal performance of the blended product lies between TMT-15 and polymeric DTC.

### Example 2. Aquatic Toxicity

The aquatic toxicity of the supernatant was evaluated using Daphnia magna (Taiwan EPS Standard procedure NIEA B901.14B) for about a 1:1 and 3:1 w/w blended product of TMT-15 and polymeric DTC solution. The same wastewater sample was used and all copper removal reagent dosages were set at about 70 ppm. The same coagulation and flocculant procedures were followed as in example 1. To better mimic industrial settings, the solution was allowed to settle for about 16 hours after coagulation/flocculation, the supernatant was taken out via a syringe, and then allowed to age for about 2 days before the toxicity test. The acute toxicity of the supernatant is shown in Table 1.

TABLE 1
Acute Toxicity of Supernatant toDaphnia Magna

| | | TMT-15: | TMT-15: | |
|---|---|---|---|---|
| | | Polymeric | Polymeric | |
| | | DTC solution | DTC solution | Polymeric |
| | TMT-15 | 3:1 w/w | 1:1 w/w | DTC |
| Acute | <1 | <1 | <1 | 3.19 |
| Toxicity | | | | |
| (TUa) | | | | |

Polymeric DTC has much higher toxicity than TMT-15 or the blended product. Surprisingly, the about 1:1 or 3:1 w/w blends displayed low toxicity. Due to the polymeric nature of polymeric DTC, it is believed that the polymeric DTC may be inclined to attach itself to flocs formed by copper and TMT, leaving the residual amount of DTC in the supernatant of the blended products to be very small. This lower residual of polymeric DTC in the supernatant may greatly reduce the aquatic toxicity.

### Example 3. Coagulating Ability

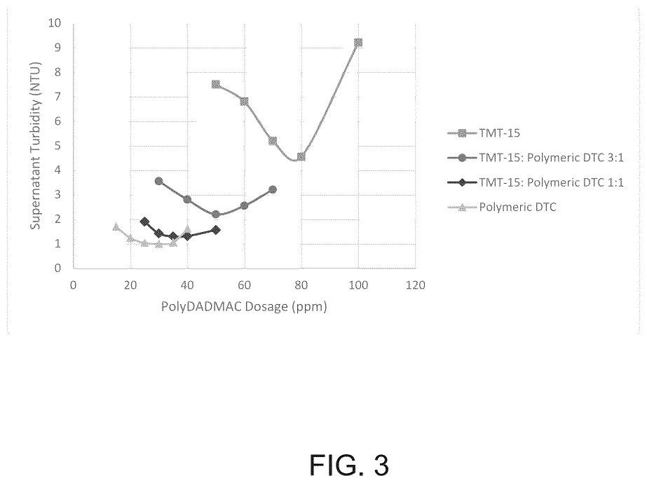

The coagulating ability for about 1:1 and 3:1 w/w blended products of TMT-15 and polymeric DTC solution was investigated using the coagulant polydiallyldimethylammonium chloride (PolyDADMAC 20% actives, weight average molecular weight of about 200,000 g/mol). The same wastewater sample from example 1 was used, and all copper removal reagent dosages were set at about 70 ppm. The coagulant dosages varied from about 15-100 ppm and flocculant dosage was set at about 1 ppm. The same coagulation and flocculant procedures were followed as in example 1 and the turbidity of the supernatant was measured after settling for about 20 minutes. The results are shown in FIG. 3.

The coagulating performance of TMT-15 was worse than polymeric DTC. This is not a surprising result, as TMT is a small molecule precipitant and forms very fine flocs with copper. Polymeric DTC, on the other hand, has self-coagulating abilities and forms large flocs with copper, meaning a lower dosage of the coagulant is needed and lower turbidity can be achieved. Interestingly, the performance of blended product of TMT-15 and polymeric DTC is much closer to polymeric DTC than TMT-15, suggesting a synergistic effect. Therefore, similar coagulating performance can be achieved with a fraction of polymeric DTC in the blend.

### Example 4. Copper Removal

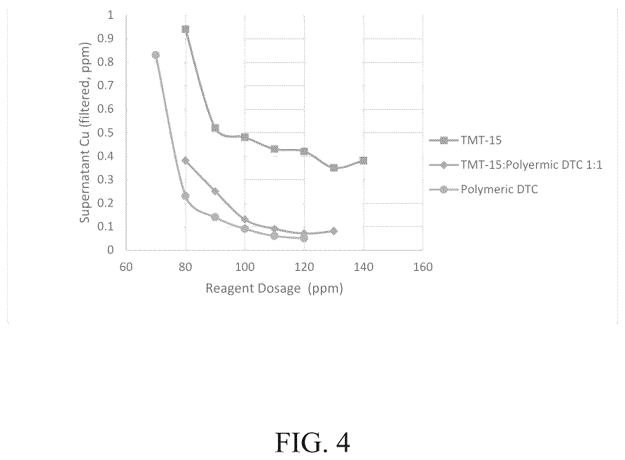

Another copper CMP wastewater sample was taken from a semiconductor fabrication plant and the copper removal performance was tested for the individual components and 1:1 w/w blends of TMT-15 and polymeric DTC based on acrylic acid and tetraethylenepentamine copolymer (30% aqueous solution). The wastewater contained about 5.6 ppm copper. The procedure followed was in accordance with Example 1. The results are shown in FIG. 4. For this case, TMT-15 can only reduce copper down to ˜0.4 ppm even with excess dosage but the polymeric DTC and the blended reagent can lower copper to <0.1 ppm level.

### Example 5. Aquatic Toxicity

The acute aquatic toxicity of the supernatant in Example 4 was evaluated using Daphnia magna (Taiwan EPS Standard procedure NIEA B901.14B). Dosages were set at 120 ppm. The testing conditions were the same as Example 2 and the acute toxicity of the supernatant is shown in Table 2.

TABLE 2
Acute Toxicity of Supernatant against Daphnia Magna

| | | TMT-15: | |
|---|---|---|---|
| | | Polymeric | |
| | | DTC solution | Polymeric |
| | TMT-15 | 1:1 w/w | DTC |
| Acute | 1.14 | 1.28 | >5 |
| Toxicity | | | |
| (TUa) | | | |

As can be seen, the 1:1 blended reagent and TMT-15 showed low aquatic toxicity while polymeric DTC alone has much higher toxicity.

### Example 6. Coagulating Ability

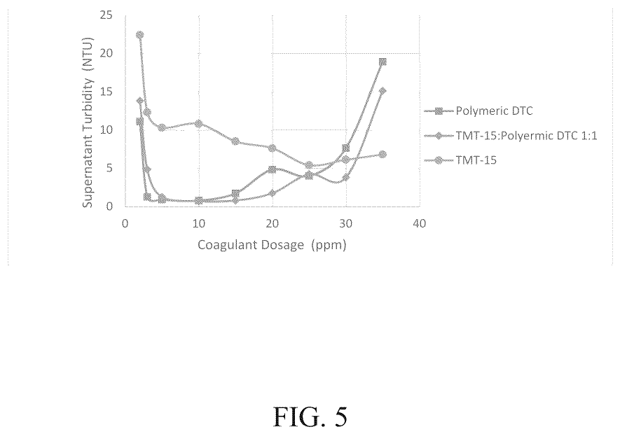

The coagulating ability for individual components and 1:1 w/w blended reagent of TMT-15 and polymeric DTC solution was investigated using the coagulant polydiallyldimethylammonium chloride (PolyDADMAC 20% actives, weight average molecular weight of about 200,000 g/mol). The same wastewater sample from Example 4 was used, and all copper removal reagent dosages were set at 120 ppm. The coagulant dosages varied from about 2 ppm to about 35 ppm and flocculant dosage was set at about 1 ppm. The same coagulation and flocculant procedures were followed as in Example 1 and the turbidity of the supernatant was measured after settling for about 20 minutes. The results are shown in FIG. 5. It can be seen that the blended reagent has a similar low turbidity and wide coagulant dosage window as polymeric DTC while TMT-15 has much worse turbidity level in the supernatant.

In summary, the inventors unexpectedly discovered that surprisingly superior performance can be achieved by blending a polymeric DTC solution and TMT solution in terms of copper removal, aquatic toxicity and coagulation.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a solvent” is intended to include “at least one solvent” or “one or more solvents.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition for the treatment of a medium, comprising:
trimercapto-s-triazine (TMT); and
a polymer comprising a dithiocarbamate (DTC) functional group;
wherein the weight average molecular weight of said polymer is between about 500 to about 200,000 g/mol,
wherein said polymer has between about 5 to about 100 mol % of said DTC functional group, and
wherein the composition comprises a mole ratio of TMT to DTC of about 1:1 to about 1:9.

2. The composition of claim 1, wherein the polymer has about 30 mol % to about 80 mol % of the DTC functional group.

3. The composition of claim 1, wherein the polymer is derived from a reaction of an amine functionalized polymer backbone with CS₂.

4. The composition of claim 3, wherein the amine functionalized polymer is selected from the group consisting of a polyethyleneimine, a copolymer of ethylenedichloride and ammonia, a polyamidoamine, a polyallylamine, a polymer comprising acrylic acid or a derivative thereof and an alkylamine, a polymer comprising methacrylic acid or a derivative thereof and an alkylamine, and any combination thereof, wherein the alkylamine is selected from the group consisting of an ethylenediamine (EDA), a diethylenetriamine (DETA), a triethylenetetraamine (TETA), a tetraethylenepetamine (TEPA), a pentaethylenehexamine (PEHA), and any combination thereof.

5. The composition of claim 1, wherein the TMT further comprises a solvent, which comprises about 40% to about 95% of the total weight.

6. The composition of claim 1, wherein the polymer comprising the DTC functional group further comprises a solvent, which comprises about 40% to about 95% of the total weight by weight of the polymer.

7. The composition of claim 1, wherein the composition comprises about 2-10% by weight of the TMT and about 5-20% by weight of the polymer comprising the DTC functional group.

8. The composition of claim 1, further comprising an aqueous solvent.

9. A method of removing a metal from a medium, comprising:
adding TMT and a polymer comprising a DTC functional group to the medium; and
separating a precipitate comprising the metal from the medium;
wherein the weight average molecular weight of said polymer is between about 500 to about 200,000 g/mol,
wherein said polymer has between about 5 and about 100 mol % of said DTC functional group, and
wherein the TMT and the DTC functional group in the polymer are added at a mole ratio of about 1:1 to about 1:9.

10. The method of claim 9, wherein the polymer has about 30 mole % to about 80 mole % of the DTC functional group.

11. The method of claim 9, wherein the TMT and the polymer are premixed to form a composition and the composition is added to the medium.

12. The method of claim 9, wherein the TMT is added to the medium before, after, and/or with the polymer.

13. The method of claim 9, wherein the separating is carried out by a process selected from the group consisting of sedimentation/decanting, filtration, flotation, and any combination thereof.

14. The method of claim 9, wherein the TMT further comprises a solvent, the solvent comprising from about 40-95% of the total weight.

15. The method of claim 9, wherein the polymer further comprises a solvent, the solvent comprising from about 40-95% of the total weight.

16. The method of claim 9, wherein the composition comprises about 2-10% by weight of the TMT and about 5-20% by weight of the polymer comprising the DTC functional group.

17. The method of claim 9, wherein a measured supernatant turbidity of the medium after addition of the TMT and polymer is less than about 3 nephelometric turbidity units (NTU).

18. The method of claim 9, wherein the composition is added to the medium at a concentration of about 1 ppm to about 1,000 ppm per ppm of metal present in the medium.

19. The method of claim 9, wherein the medium is an aqueous medium.

20. The method of claim 9, further comprising adding a member selected from the group consisting of a pH adjustment reagent, a coagulant, a flocculant, and any combination thereof, to the medium.
